(19) United States
(12) Patent Application Publication
(10) Pub. No.: US 2016/0204420 A1
(43) Pub. Date: Jul. 14, 2016

(54) ACTIVE ELECTROCHEMICAL MATERIAL AND PRODUCTION OF SAME

(71) Applicant: VARTA MICRO INNOVATION GMBH, Graz (AT)

(72) Inventors: Stephania Toulis, Proleb (AT); Michaela Scharfegger, Graz (AT); Harald Kren, Graz (AT); Stefan Koller, Graz (AT)

(21) Appl. No.: 14/911,760

(22) PCT Filed: Jun. 12, 2014
(86) PCT No.: PCT/EP2014/062249

§ 371 Date: Feb. 12, 2016

(30) Foreign Application Priority Data
Aug. 12, 2013 (EP) 13180122.7

(51) Int. Cl. H01M 4/36; H01M 4/62; H01M 4/04; H01M 10/052; H01M 4/38; H01M 4/587

(52) U.S. Cl. CPC H01M 4/366; H01M 4/386; H01M 4/587; H01M 4/0471; H01M 10/052; H01M 4/625

(57) ABSTRACT

A process of producing active material for an electrode of an electrochemical cell includes a buildup step A in which a pulverulent composite composed of lithium-intercalating carbon particles as component 1, silicon particles as component 2 and a polymer that can be pyrolyzed to form amorphous carbon as component 3 is formed, and a pyrolysis step B in which the composite is heat treated in the absence of atmospheric oxygen at a temperature at which the pyrolyzable polymer decomposes to form amorphous carbon, wherein the lithium-intercalating carbon particles are transferred in the buildup step A into a fluidized-bed reactor and coated with a shell composed of the polymer and the silicon particles to effect direct formation of the pulverulent composite, and the polymer that can be pyrolyzed to form amorphous carbon or a corresponding polymer precursor and/or the silicon particles are fed into the fluidized-bed-reactor as solution or suspension.

### TECHNICAL FIELD

This disclosure relates to a process of producing active material for an electrode of an electrochemical cell, active material produced by the process, and electrodes and electrochemical cells having such an active material.

### BACKGROUND

The term “battery” originally meant a plurality of electrochemical cells arranged in series in a housing. However, individual electrochemical cells are frequently referred to as a battery. During discharge of an electrochemical cell, an energy-producing chemical reaction made up of two electrically coupled, but spatially separated subreactions takes place. A subreaction taking place at a comparatively low redox potential proceeds at the negative electrode, and a subreaction taking place at a comparatively higher redox potential proceeds at the positive electrode.

During discharging, electrons are liberated by an oxidation process at the negative electrode, resulting in an electron current through an external load to the positive electrode by which a corresponding number of electrons is taken up. A reduction process thus takes place at the positive electrode. At the same time, an ion current corresponding to the electrode reaction flows within the cell. This ion current is ensured by an ionically conductive electrolyte.

In secondary cells and batteries, this discharging reaction is reversible and it is thus possible to reverse the conversion of chemical energy into electric energy taking place during discharging. When the terms “anode” and “cathode” are used in this context, the electrodes are generally named according to their function during discharging. The negative electrode in such cells is thus the anode, while the positive electrode is the cathode.

Among secondary cells and batteries, comparatively high energy densities are achieved by cells and batteries based on lithium ions. These generally have composite electrodes comprising an electrochemically inactive component in addition to electrochemically active components. Possible electrochemically active components (often also referred to as electrochemical active material or, for short, active material) for cells and batteries based on lithium ions are in principle all materials which can take up lithium ions and release them again. In this respect, the prior art discloses, in particular, carbon-based particles, for example, graphitic carbon or nongraphitic carbon materials capable of intercalating lithium, for the negative electrode. Furthermore, metallic and semimetallic materials which can be alloyed with lithium can also be used. Thus, for example, the elements tin, antimony and silicon are able to form intermetallic phases with lithium. Active materials used industrially at the present time for the positive electrode are, in particular, lithium cobalt oxide (LiCoO₂), LiMn₂O₄ spinel, lithium iron phosphate (LiFePO₄) and derivatives such as LiNi_{1/3}Mn_{1/3}CO_{1/3}O₂ or LiMnPO₄. All electrochemically active materials are generally present in particle form in the electrodes.

As electrochemically inactive components, mention may be made first and foremost of electrode binders and power outlet leads. Electrons are supplied to or conducted away from the electrodes via power outlet leads. Electrode binders ensure mechanical stability of the electrodes and also contacting of the particles of electrochemically active material with one another and with the power outlet lead. Conductivity-improving additives, which can likewise be subsumed under the collective term “electrochemically inactive components,” can contribute to improved electrical connection of the electrochemically active particles to the power outlet lead. All electrochemically inactive components should be electrochemically stable, at least in the potential range of the respective electrode, and be chemically inert toward customary electrolyte solutions. Customary electrolyte solutions are, for example, solutions of lithium salts such as lithium hexafluorophosphate in organic solvents such as ethers and esters of carbonic acid.

WO 2010/014966 A1 discloses an active material for electrodes of lithium ion batteries containing nanosize silicon particles. These are embedded, optionally together with carbon particles, in a polymer electrolyte. The polymer electrolyte evens out volume fluctuations of the silicon particles and optionally the carbon particles during charging and discharging processes.

Composites composed of graphite and silicon are also known. Thus, for example, an active material having a core-shell structure is disclosed in DE 10 2008 063 552 A1. The core consists of a graphite particle and the shell consists of metallic silicon which can be formed by thermal decomposition of a silane. US 2006/0035149 A1 discloses an active material which can comprise carbon fibers in addition to silicon-carbon composite particles. Furthermore, U.S. Pat. No. 6,589,696 B2 discloses an active material comprising graphite particles on the surface of which microparticulate silicon particles embedded in an amorphous carbon film are arranged.

US 2005/0136330 A1 and US 2009/0252864 A1 disclose active materials for lithium ion batteries comprising silicon-carbon composite particles. The latter are produced by coating silicon particles with a coating material from the group consisting of petroleum, tar, phenolic resins, sugars, polyacrylonitrile and lignin followed by pyrolysis of the decomposition material.

It is important for the performance of secondary lithium ion cells that a covering layer generally consisting of electrolyte decomposition products and oxidized lithium is formed on the surface of the electrochemically active materials in the anode as early as during the first charging/discharging cycle of such cells (known as activation). This covering layer is referred to as “solid electrolyte interface” (SEI). The SEI is in the ideal case permeable only to the extremely small lithium ions and prevents further direct contact of the electrolyte solution with the electrochemically active material in the anode. In this respect, formation of the SEI has entirely positive effects. However, a disadvantage is that lithium is lost as a result of formation of the SEI and the internal resistance of the cell also rises at the same time.

EP 2573845 A1 discloses a process of producing an active material for electrodes resulting in lithium-intercalating carbon particles coated in a shell-like manner by an amorphous carbon layer in which the silicon particles are embedded. These can be used as active material for the electrodes of electro chemical cells and as such display a very high cycling stability. The amorphous carbon layer inhibits contact of the silicon particles and the lithium-intercalating carbon particles with the electrolyte of the cells and thus prevents excessive losses of lithium as can occur in the SEI formation described. Compared to the process described in U.S. Pat. No. 6,589,696 B2, very much smaller, nano silicon particles are used.

It could nonetheless be helpful to achieve a further improvement in the known active materials for electrodes, in particular composites composed of graphite and silicon.

Summary

We provide a process of producing active material for an electrode of an electrochemical cell including a buildup step A in which a pulverulent composite composed of lithium-intercalating carbon particles as component 1, silicon particles as component 2 and a polymer that can be pyrolyzed to form amorphous carbon as component 3 is formed, and a pyrolysis step B in which the composite is heat treated in the absence of atmospheric oxygen at a temperature at which the pyrolyzable polymer decomposes to form amorphous carbon, wherein the lithium-intercalating carbon particles are transferred in the buildup step A into a fluidizedbed reactor and coated with a shell composed of the polymer and the silicon particles to effect direct formation of the pulverulent composite, and the polymer that can be pyrolyzed to form amorphous carbon or a corresponding polymer precursor and/or the silicon particles are fed into the fluidized-bed-reactor as solution or suspension.

We also provide a process of producing active material for an electrode of an electrochemical cell including a buildup step A in which a pulverulent composite composed of lithium-intercalating carbon particles as component 1, silicon particles as component 2 and a polymer as component 3 that can be pyrolyzed to form amorphous carbon is formed, and a pyrolysis step B in which the composite is heat treated in the absence of atmospheric oxygen at a temperature at which the pyrolyzable polymer decomposes to form amorphous carbon, wherein the lithium-intercalating carbon particles are transferred in the buildup step A into a fluidizedbed reactor and coated with a shell composed of the polymer and the silicon particles to effect direct formation of the pulverulent composite.

### BRIEF DESCRIPTION OF THE DRAWINGS

FIG. 1 schematically shows a fluidized-bed reactor used in our method.

FIG. 2 schematically shows selected steps in our processes.

FIG. 3 shows a graph of the results of cycling tests.

FIG. 4 is a graph of a pore distribution.

FIG. 5 is a microphotograph of a particle.

FIGS. 6 and 7 are graphs of particle distribution.

### DETAILED DESCRIPTION

We provide a process that produces active material for electrodes of electrochemical cells, in particular cells based on lithium ion technology, i.e., material which intercalates or releases lithium ions or alloys with lithium during the charging and discharging processes described at the outset. It always comprises the following steps:

A buildup step A in which a pulverulent composite composed of lithium-intercalating carbon particles (component 1), silicon particles (component 2) and a polymer (component 3) which can be pyrolyzed to form amorphous carbon is formed. A pyrolysis step B in which the composite formed in step A is heat treated in the absence of atmospheric oxygen at a temperature at which the pyrolyzable polymer decomposes to form amorphous carbon.

In step A, lithium-intercalating carbon particles having an average particle size of 3 μm to 60 μm are preferably used to form the composite. Within this range, greater preference is given to average particle sizes of 10 μm to 30 μm. Carbon materials capable of intercalating lithium have been mentioned at the outset. The carbon particles used are particularly preferably particles having a graphite structure.

The lithium-intercalating carbon particles used preferably have a largely uniform size. The spread of the particle size distribution is preferably 0.1 to 3, in particular 0.5 to 2.0, particularly preferably 0.75 to 1.25. It can be determined by the formula (d90-d10)/d50, in which the d50 value is the average particle size and the difference d90-d10 is the breadth of the particle size distribution. For explanation: a d90 of 30 μm says, for example, that 90% of the particles of a distribution have a size of 30 μm or less, a d10 of 20 μm says that 10% of the particles of a distribution have a size of 20 μm or less. From this, it is possible to calculate a breadth of the particle size distribution of 10 μm. If the average particle size d50 of the distribution is, for example, 25 μm, a spread of the particle size distribution of 0.4 can be calculated therefrom.

The silicon particles used in step A to form the composite are preferably nanosize and preferably have an average particle size of 30 nm to 300 nm. Within this range, greater preference is given to average particle sizes of 50 nm to 200 nm, in particular 80 nm to 150 nm.

The silicon particles preferably also have a largely uniform size. The spread of the particle size distribution is preferably 0.1 to 3, in particular 0.5 to 2.0.

It is also possible in principle to use other metal or semimetal particles capable of alloying with lithium, for example, particles composed of tin, germanium, aluminum or antimony in place of silicon particles. Furthermore, mixtures and/or alloys of the materials mentioned can be used.

The polymer which can be pyrolyzed to form amorphous carbon is preferably selected from the group consisting of epoxy resin, polyurethane resin and polyester resin. These materials can decompose at sufficiently high temperatures on contact with the nanosize silicon particles without excessive oxidation of the silicon used occurring.

An epoxy resin, in particular an epoxy resin based on bisphenol A and epichlorohydrin, is particularly preferably used as component 3. Both bisphenol A and epichlorohydrin are adequately known as starting materials for epoxy resins and do not have to be discussed further.

It is a particular characteristic of the process that, to form the composite, the lithium-intercalating carbon particles are transferred in the buildup step into a fluidized-bed reactor and coated in this with a shell composed of the polymer and the silicon particles which for this purpose are likewise fed into the reactor. The composite is obtained directly in powder form, in contrast to known processes in which the composite obtained firstly has to be converted into powder form by appropriate mechanical treatment, in particular before the pyrolysis step B.

The individual particles of the composite powder each comprise lithium-intercalating carbon particles coated in a shell-like manner by a layer composed of the pyrolyzed polymer in which the silicon particles are embedded.

It is possible for the composite to comprise amorphous carbon black, graphenes and/or carbon nanotubes (CNTs) as component 4 in addition to the components 1 to 3.

To produce the pulverulent composite, the lithium-intercalating carbon particles are preferably fed into an uplift zone of the fluidized-bed reactor where they can be brought by an upflowing carrier gas into a fluidized state and form a fluidized bed. The fluidized bed can be a stationary fluidized bed in which the layer of the fluidized particles has a distinct upper boundary and from which only very few (fine) particles are carried out. Gravity and uplift maintain the balance. As an alternative, the fluidized bed can also be a circulating fluidized bed in which the layer of the fluidized particles no longer has a distinct upper boundary because of a greater flow velocity of the carrier gas and a large quantity of particles are carried out in an upward direction. These can fall back or they are recirculated.

As carrier gas, air can be employed in the simplest case. Preferably, oxygen-free inert gases such as nitrogen can also be used. In general, the carrier gas flows from the bottom upward under superatmospheric pressure in the uplift zone. As the uplift zone, it is possible, for example, for a vertical tube to be arranged in the reactor.

Preference is given to the polymer which can be pyrolyzed to form amorphous carbon or a corresponding polymer precursor being fed as a solution or suspension into the fluidized-bed reactor, in particular in finely divided form. The same also applies to the silicon particles and to the carbon black if used. The corresponding suspension or solution can for this purpose be, for example, blown or sprayed by a nozzle in the form of a fine spray mist into the reactor.

When a polymer precursor is used, a hardener is preferably added to this. The hardener can preferably be an amine hardener when epoxy resins are used as component 3. Such hardeners for epoxy resins are also known and require no further explanation. Particular preference is given to using 3-(dimethylamino)-1-propylamine as amine hardener.

Addition of the components 2 and 3, optionally also 4, can be carried out either simultaneously or in succession or alongside. For example, a solution or suspension containing all components 1 to 3 or at least two of these components can be fed in. As an alternative, for example, a solution of component 3, a suspension of component 1 and optionally a suspension of component 4 can be introduced separately, either simultaneously or in succession.

To produce a solution or suspension comprising all components 2 to 4, we found that it is particularly advantageous to place the component 3 as a solution in a solvent in a vessel and subsequently disperse the components 2 and optionally 4 in this solution. It can be useful to subject the components 2 and optionally 4 to predispersion in the solvent, i.e., add these components in dispersed form to the solution composed of component 3 and the solvent. Suitable solvents are, for example, alcohols such as 1-methoxy-2-propanol, in particular in epoxy resins as component 3.

The proportions of the components 2 to 4 in the solution or suspension are preferably set as follows:

The proportion of silicon particles is preferably 0.5% by weight to 10% by weight, in particular 1% by weight to 5% by weight.

The proportion of component 4 is preferably 0% by weight to 5% by weight, in particular 0% by weight to 2% by weight.
The proportion of the pyrolyzable polymer or polymer precursor is preferably 0.5% by weight to 10% by weight, in particular 1% by weight to 5% by weight. These figures optionally include from 0% by weight to 1% by weight of a hardener.

The weights indicated are preferably based on the total weight of the solution or suspension, i.e., on the sum of the weights of the components 2 to 4 and the weight of the solvent or suspension medium.

Solvent or suspension medium present in the solution or suspension is preferably evaporated or vaporized in the fluidized-bed reactor and discharged from the fluidized-bed reactor, preferably with the carrier gas. For this purpose, the temperature of the carrier gas and thus the interior of the fluidized-bed reactor can be 20° C. to 60° C.

The polymer which can be pyrolyzed to form amorphous carbon (or a corresponding polymer precursor) and/or the silicon particles and/or the conductive carbon black are preferably fed directly, in particular in the form of the abovementioned suspensions or solutions, into the uplift zone of the fluidized-bed reactor, in particular directly below the fluidized bed or directly into the fluidized bed.

Preferably, particles are discharged from the fluidized bed and transferred into a settling zone of the fluidized-bed reactor in which the force of gravity acting on them is greater than the uplift force they experience. This is particularly preferred in the abovementioned circulating fluidized bed. The particles can be recirculated via the settling zone, i.e., fed back into the uplift zone. As an alternative, particles which have been discharged can also be conveyed out of the reactor.

Particularly preferably, particles are discharged, preferably continuously, from the fluidized bed and thus from the uplift zone and partly recirculated via the settling zone back into the uplift zone. Filtering and separation of the particles into two or more particle fractions, for example, a first fraction comprising particles below a weight threshold value and a second fraction having a weight above the threshold value, can be effected as a function of the weight of the particles discharged. Since the lithium-intercalating carbon particles used preferably have a largely uniform size, in particular within the above-mentioned limits, and consequently also a largely uniform weight at the beginning of the coating process in the fluidized-bed reactor, the weight of the particles discharged from the fluidized bed generally allows a conclusion to be drawn as to the state of the coating process. The heavier a particle, generally the thicker the shell composed of the polymer and the silicon particles with which the particle has been coated.

Setting of the weight threshold value allows the coating process and the thickness of the coating to be controlled, which in turn allows active material particles having a “designable” capacity to be produced. If the weight threshold value is increased, this also increases the average residence time of the particles in the fluidized-bed reactor and thus also the thickness of the polymer shell formed. This enables the C/Si ratio in the particles to be influenced. The thicker the shell, the larger (relative to the core-forming lithium-intercalating carbon particles) the proportion by weight of silicon in the composite particles.

It is possible, for example, for the abovementioned first particle fraction to be recirculated while the abovementioned second particle fraction is discharged from the reactor. While the coating process for the particles of the first fraction is not yet concluded, the shell of the particles of the second fraction already has the desired thickness.

Further possible process parameters via which the coating process can be controlled are the velocity of the carrier gas stream (which likewise influences the residence time of the particles in the fluidized bed) and the spraying pressure and thus the velocity with which the components 2 to 4 are blown or sprayed into the reactor.

In the heat treatment in step B, the particles obtained in step A are preferably exposed to a temperature of 500° C. to 1100° C. The precise temperature is dependent primarily on the nature of the material of component 3. When an epoxy resin is used as component 3, the temperature is preferably 600° C. to 1000° C.

We surprisingly found that the particles produced in step A do not tend to form agglomerates even when they contact one another during the pyrolysis step B. Step B therefore also preferably results in a powder. This usually applies both when the heat treatment is carried out in a manner analogous to step A with a fluidized-bed reactor and also when, for example, it is carried out in a rotary tube furnace. For this purpose, the powder to be pyrolyzed in a fluidized-bed pyrolysis reactor can be brought by an upward-flowing carrier gas into a fluidized state and subjected to the temperatures mentioned at which the component 3 decomposes into amorphous carbon.

It may be preferable to carry out the heat treatment in a reducing atmosphere or at least a nonoxidizing atmosphere. We found that it is advantageous to exclude atmospheric oxygen as far as possible during the treatment. For example, the treatment can be carried out under protective gas. Thus, for example, nitrogen can be used as carrier gas in the fluidized-bed pyrolysis reactor.

We also provide active material produced by the process. It is particularly suitable for the negative electrode of an electrochemical cell, in particular a lithium ion cell. In accordance with what has been said above, it comprises lithium-intercalating carbon particles whose surface is at least partly covered in a shell-like manner with a layer of amorphous carbon in which nanosize silicon particles having a preferred average particle size of 30 nm to 300 nm are embedded. The active material particularly preferably consists of such particles.

The shell of the particles preferably has at least one of the following properties:
It is porous, and in particular has pores having an average pore diameter of 10 to 200 nm, particularly preferably 50 to 150 nm.
It has a BET surface area of 3 m²/g to 100 m²/g, preferably 5 m²/g to 50 m²/g, in particular 8 m²/g to 30 m²/g.
   The pore distribution is preferably monomodal.

The abovementioned BET surface area values are surprisingly very significantly below the values determined for silicon-graphite composite particles obtained by classical processes as described, for example, in EP 2573845 A1. The comparatively low BET surface area is advantageous. The lithium and electrolyte losses associated with the SEI formation mentioned at the outset were very much smaller than expected.

Particularly preferably, the particles can also have at least one further shell surrounding them in addition to the shell composed of the amorphous carbon with the silicon particles embedded therein. It is easily possible for the pyrolysis step B to be followed by a second buildup step A in which particles resulting from step B are fed in place of the lithium-intercalating carbon particles into the uplift zone of the fluidized-bed reactor. The surface of these can once again be coated with the (or an alternative) polymer which can be pyrolyzed to form amorphous carbon and can subsequently be decomposed again into amorphous carbon in a second pyrolysis step B.

The active material has a very high cycling stability. The amorphous carbon layer inhibits contact of the silicon particles and the lithium-intercalating carbon particles with the electrolyte of the cells and thereby prevents excessive losses of lithium, as can occur in the SEI formation described above.

The process makes it possible to achieve very uniform coating of the lithium-intercalating carbon particles used. As a consequence, completely surprisingly, not only the lithium-intercalating carbon particles used (and optionally the silicon particles used) but generally also the particles obtained from step B have a largely uniform size. The spread of the particle size distribution of the particles obtained from step B is preferably 0.1 to 3, in particular 0.5 to 2.0, particularly preferably 0.75 to 1.25. This can be advantageous in respect of very uniform electrode loading and electrode kinetics.

The active material can be processed further together with an electrode binder such as sodium carboxymethyl cellulose and optionally a conductivity-improving additive to produce an electrode for lithium ion cells, in particular a negative electrode. Such electrodes and electrochemical cells comprising such electrodes are also provided.

The active material represents an alternative to the conventional anode material graphite for lithium ion batteries. The combination of the structurally stable, comparatively low-capacity lithium-intercalating carbon particles with the high-capacity nanosilicon enables an extraordinarily structurally stable anode material for lithium ion batteries to be developed. The core-shell structure and the use of nanosilicon in the anode material enables structural lability during charging/discharging of the silicon to be circumvented and a structurally stable anode material has thus been able to be produced despite the large volume and structure changes during charging/discharging when silicon is used.

Further features can be derived from the following description of the figures and preferred examples in conjunction with the appended claims. Individual features can be realized on their own or as a plurality thereof in combination with one another in an example. The preferred examples described serve merely for the purpose of illustration and for better understanding and do not in any way constitute a restriction.

### EXAMPLE

### Production of an Active Material

As indicated above, the process can be divided into two clearly separable process steps, viz. a buildup step A and a pyrolysis step B.

In step A, 28 g of graphite particles having an average particle size of 10 μm to 50 μm are transferred into the uplift zone of a fluidized-bed reactor (laboratory scale, reactor Mini Glatt from Glatt GmbH, Binzen, Germany) and they are brought by upflowing compressed process air into a fluidized state with formation of a fluidized bed. The process air pressure in the laboratory reactor is generally 0.02 to 0.2 bar (depending on the particles used). The particles are subsequently coated with a polymer shell in which silicon particles having particle sizes of 10-500 nm and also carbon black particles are embedded. For this purpose, a suspension composed of a solvent, a suitable polymer, the silicon particles and the carbon black particles is sprayed into the reactor. Particularly suitable polymers are epoxy resins based on bisphenol A and epichlorohydrin. A typical solution or suspension which is sufficient for coating the indicated amount of graphite particles is made up of the following components:
240 g of 1-methoxy-2-propanol (solvent or suspension medium)
8 g of epoxy resin Araldite® 506 (as pyrolyzable polymer)
2 g of 3-dimethylaminopropylamine (as hardener)
8 g of silicon particles
4 g of carbon black.

The temperature in the interior of the fluidized-bed reactor is about 41° C. The solution or suspension is subsequently sprayed at a pressure of about 1.3 bar through a nozzle onto the fluidized-bed of the graphite particles.

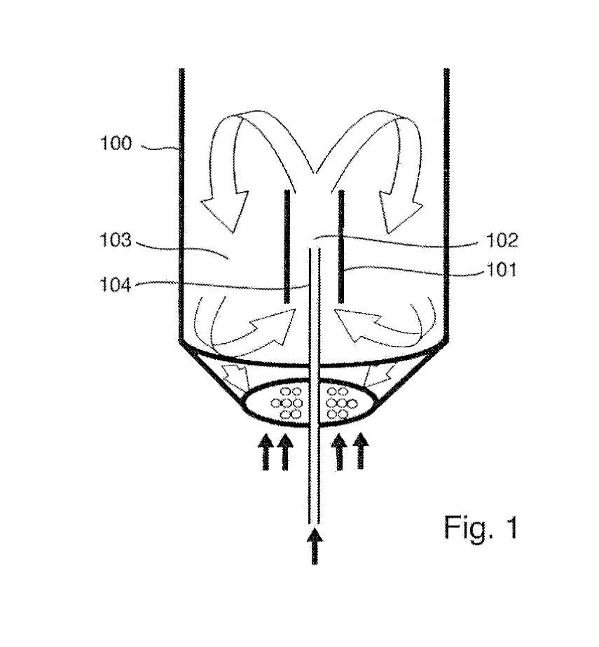

Operation of the coating process is depicted in FIG. 1. The fluidized-bed reactor 100 shown schematically in cross section has a vertical riser tube 101 into the lower end of which the compressed process air is blown as carrier gas. The tube 101 defines an uplift zone 102 within the reactor 100 in which the fluidized bed of the graphite particles is formed. The particles can circulate (in the direction indicated by arrows) within the reactor 100. When the flow velocity of the compressed process air is set appropriately within the tube 101, the particles can exit from the tube 101 at the top and reach a position where the uplift imparted to the particles by the process air pressure is smaller than the force of gravity active on them. They consequently descend outside the tube 101 through a settling zone 103 until they are again entrained by the compressed process air entering the lower end of the tube 101 and drawn into the uplift zone through which they travel again until they once again go into the settling zone 103.

The solution or suspension for coating the graphite particles is sprayed into the uplift zone 102 through the feed line 104. Suitable spraying processes are, for example, top spray coating or bottom spray coating process. As an alternative, the tangential spray coating process is also possible. The surface of the graphite particles in the uplift zone 102 is wetted by the resulting spray mist. At the temperature prevailing in the interior of the reactor 100, virtually instantaneous evaporation of the solvent or suspension medium present in the solution or suspension and also partial or complete curing of the pyrolyzable polymer deposited on the particle surfaces occurs. Appropriate (not too low) setting of the flow velocity of the compressed process air within the tube 101 prevents particle agglomeration.

Wetting the particles in the uplift zone 102 is subsequently repeated during each further passage through the zone. Accordingly, the thickness of the polymer shell formed on the particle surfaces gradually increases. Associated therewith, the weight of the coated graphite particles also gradually increases. When the weight of the particles exceeds a particular threshold value, they are no longer entrained by the compressed process air and drawn into the uplift zone 102. Instead, they can collect at the bottom of the reactor 100.

The residence time of the particles in the uplift zone 102 and thus ultimately the structure of the graphite particle can, for example, be controlled by setting of the process air pressure and selection of a suitable reactor geometry. As mentioned, this provides an opportunity of specifically setting the capacity of the active material to be produced.

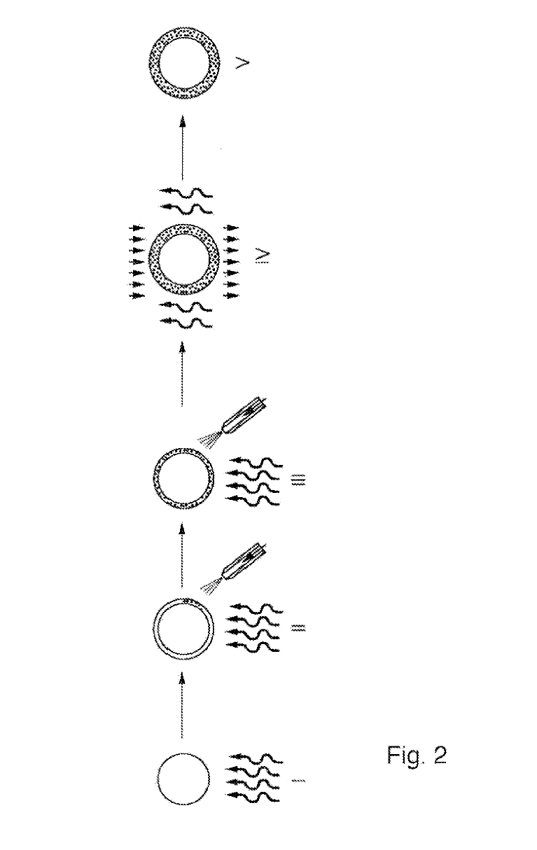

Operation of the process can also be explained in detail with the aid of the schematic depiction in FIG. 2.

First, graphite particles are made to float (I) by a carrier gas stream. Subsequently, coating of the graphite particles floating in the carrier gas stream by a coating solution as has been described above is commenced (II). The coating solution is contacted in the form of a spray mist with the floating particles. The polymer present in the coating solution cures on the surface of the particles and forms a polymer shell in which the silicon particles are embedded. Shell formation continues (III), and the thickness of the shell increases. With increasing shell thickness, the weight of the particles also increases. When a threshold value is exceeded, the force of gravity acting on the particles is no longer balanced by the uplift caused by the carrier gas stream (IV). The particles descend or are separated off in a targeted manner. Pyrolytic decomposition of the polymer shell formed is then carried out. This results in particles having a graphite core enveloped by a shell composed of amorphous carbon in which silicon particles are embedded (V).

The process described gives a pulverulent composite which decomposes in a subsequent pyrolysis step B by heating at 900° C. for 2 h in an oxygen-free atmosphere. The Si/C composite particles obtained contain, for example, 63 parts by weight of graphite, 18 parts by weight of silicon and 9 parts by weight of amorphous carbon.

### Characterization of Active Materials

A number of active material variants having different capacities were produced by the process described. For this purpose, graphite particles were provided with polymer shells having different thicknesses. The thicker the shell, the more silicon did the coated particles and thus the respective active material contain. Active materials having a proportion of silicon of 2.5, 5, 10 and 20 parts by weight of silicon were produced.

For electrochemical characterization, the active materials obtained were processed to produce electrodes. For this purpose, the active materials were processed to form aqueous pastes which contain the active materials together with sodium carboxymethyl cellulose as binder and conductive carbon black in a weight ratio of 88:7:5. The paste was applied to a copper power outlet lead and dried, followed by a calendering step.

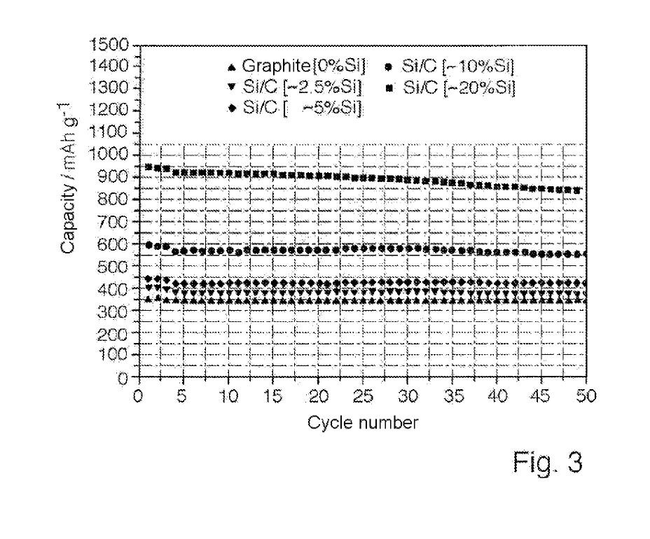

The results of the cycling tests using the electrodes produced in this way are shown in FIG. 3.

The surface of the particles is of particular interest since, during use as anode material in lithium ion batteries, the particles are at least partially exposed to the electrolyte and the electrolyte is electrochemically unstable at the prevailing potential for lithium uptake. Accordingly, a covering layer is formed reductively and this results in a disadvantageous loss of lithium and electrolyte. Accordingly, a very low specific surface area is desirable, especially when nanosize silicon is used. It has been found that the process is suitable for controlling the BET surface area by process parameters and spraying additives. In tests on the silicon-graphite composite particles resulting from the process, it was found that it was possible to realize BET surface areas of 3 m²/g to 100 m²/g. BET surface areas of 5 m²/g to 50 m²/g and particularly preferably 8 m²/g to 30 m²/g were usually obtained.

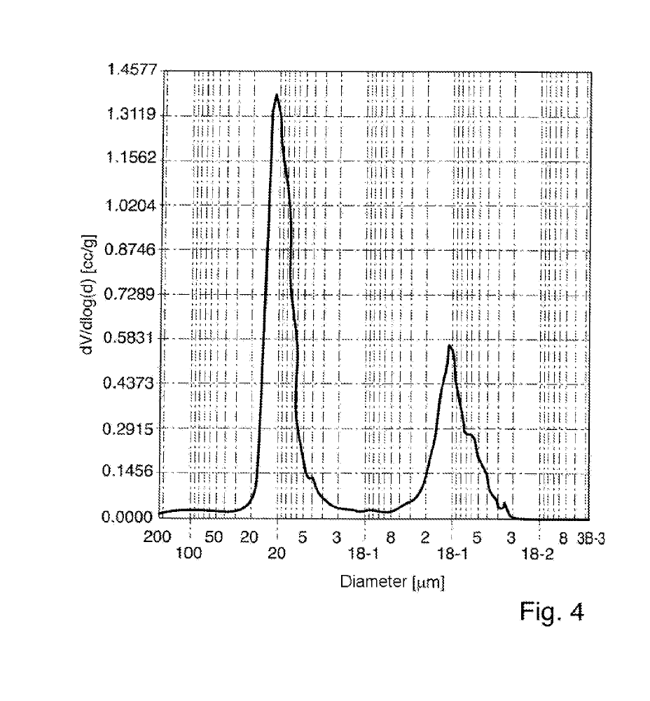

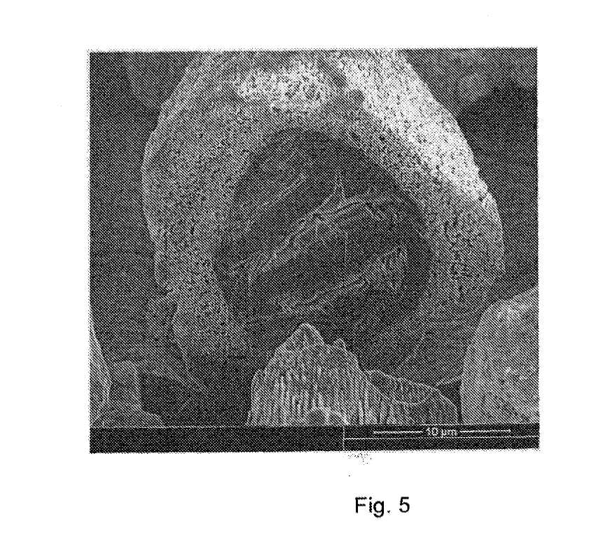

The active materials produced were subjected to a mercury porosimetry study (measurements carried out on a QUANTACHROME Poremaster 60-GT) to determine the pore size distribution. This indicated that the materials examined have an average pore size of 80 nm to 120 nm. A typical pore distribution is depicted in FIG. 4 (note: the peak at 10 μm describes the grain interstices; only the peak in the submicron range represents the pores), and one of the particles examined is shown in FIG. 5. This is a particle cut through in the middle by a focused ion beam (FIB). The (relatively dark) graphite core and the (lighter-colored) shell of amorphous carbon with silicon particles embedded therein which surrounds the core can clearly be seen.

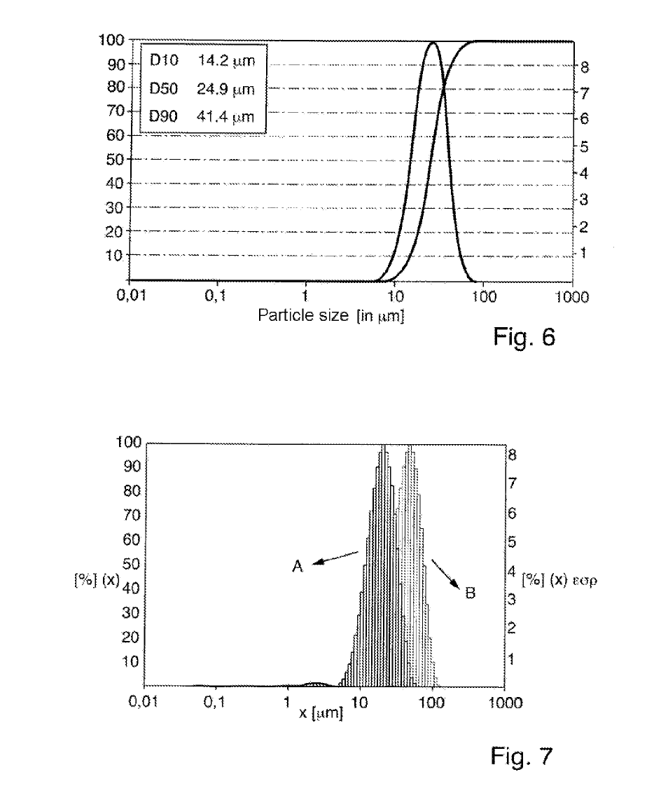

The process allows the particles to be separated according to size and weight. Furthermore, the process allows agglomerates to be ruled out. Accordingly, very homogeneous particle size distributions are generally obtained. Examples of such distributions are depicted in FIGS. 6 and 7 (FIG. 7 shows a comparison between two particle sizes distributions, namely the size distribution of the carbon particles used in step A and of the particles obtained from step B).

1-14. (canceled)

15. A process of producing active material for an electrode of an electrochemical cell comprising:
a buildup step A in which a pulverulent composite composed of lithium-intercalating carbon particles as component 1, silicon particles as component 2 and a polymer that can be pyrolyzed to form amorphous carbon as component 3 is formed, and
a pyrolysis step B in which the composite is heat treated in the absence of atmospheric oxygen at a temperature at which the pyrolyzable polymer decomposes to form amorphous carbon,
wherein the lithium-intercalating carbon particles are transferred in the buildup step A into a fluidized-bed reactor and coated with a shell composed of the polymer and the silicon particles to effect direct formation of the pulverulent composite, and
the polymer that can be pyrolyzed to form amorphous carbon or a corresponding polymer precursor and/or the silicon particles are fed into the fluidized-bed-reactor as solution or suspension.

16. A process of producing active material for an electrode of an electrochemical cell comprising:
a buildup step A in which a pulverulent composite composed of lithium-intercalating carbon particles as component 1, silicon particles as component 2 and a polymer as component 3 that can be pyrolyzed to form amorphous carbon is formed, and
a pyrolysis step B in which the composite is heat treated in the absence of atmospheric oxygen at a temperature at which the pyrolyzable polymer decomposes to form amorphous carbon,
wherein the lithium-intercalating carbon particles are transferred in the buildup step A into a fluidized-bed reactor and coated with a shell composed of the polymer and the silicon particles to effect direct formation of the pulverulent composite.

17. The process of claim 16, wherein the components 1 to 3 have at least one of the following features:
the lithium-intercalating carbon particles have an average particle size of 3 μm to 60 μm,
the spread of the particle size distribution of the lithium-intercalating carbon particles is 0.1 to 3,
the silicon particles have an average particle size of 30 nm to 300 nm,
the spread of the particle size distribution of the silicon particles is 0.1 to 3, and
the polymer that can be pyrolyzed to form amorphous carbon is selected from the group consisting of epoxy resin, polyurethane resin and polyester resin.

18. The process of claim 16, wherein, to produce the pulverulent composite, the lithium-intercalating carbon particles are fed into an uplift zone of the fluidized-bed reactor where they are brought by an upward-flowing carrier gas into a fluidized state and form a fluidized bed.

19. The process of claim 16, wherein
the polymer which can be pyrolyzed to form amorphous carbon or a corresponding polymer precursor and/or
the silicon particles and, optionally,
conductive carbon black, graphenes and/or CNTs (as component 4)
are fed as a solution or suspension into the fluidized-bed reactor in finely divided form.

20. The process of claim 18, wherein the polymer which can be pyrolyzed to form amorphous carbon, or a corresponding polymer precursor, and/or the silicon particles and/or the component 4 are fed into the uplift zone of the fluidized-bed reactor directly below the fluidized bed or directly into the fluidized bed.

21. The process of claim 17, wherein particles are discharged from the fluidized bed and transferred into a settling zone of the fluidized-bed reactor in which the force of gravity acting on them is greater than the uplift force.

22. The process of claim 21, wherein the particles discharged from the fluidized bed are conveyed out of the reactor and/or fed back into the uplift zone via the settling zone.

23. The process of claim 16, wherein the mass ratio C/Si in the particles and the capacity of the active material formed is controlled via residence time of the particles in the fluidized-bed reactor.

24. The process of claim 23, wherein the residence time is set by setting the flow velocity of the upward-flowing carrier gas.

25. The process of claim 19, wherein the polymer which can be pyrolyzed to form amorphous carbon, or a corresponding polymer precursor, and/or the silicon particles and/or the component 4 are fed into the uplift zone of the fluidized-bed reactor directly below the fluidized bed or directly into the fluidized bed.
